(19) United States
(12) Patent Application Publication
(10) Pub. No.: US 2015/0325861 A1
(43) Pub. Date: Nov. 12, 2015

(54) PLATINUM AND PALLADIUM ALLOYS SUITABLE AS FUEL CELL ELECTRODES

(71) Applicant: Denmarks Tekniske Universitet, Lyngby (DK)

(72) Inventors: Ifan Erfyl Lester Stephens, Copenhagen K (DK); Jan Rossmeist, Lynge (DK); Maria Escudero Escribano, Copenhagen Ø (DK); Amau Verdaguer-Casadevall, Nærum (DK); Paolo Malacrida, Copenhagen Ø (DK); Ulrick Grønbjerg Vej-Hansen, Virum (DK); Brian Peter Knudsen, Nærum (DK); Anders Konge Jepsen, Kgs. Lyngby (DK); Ib Chorkendorff, Birkerød (DK)

(21) Appl. No.: 14/410,226

(22) PCT Filed: Jul. 5, 2013
(86) PCT No.: PCT/DK2013/050229

§ 371 Date: Dec. 22, 2014

(30) Foreign Application Priority Data
Jul. 6, 2012 (EP) 12175450.1

(51) Int. Cl. H01M 4/92; H01M 8/10; C22C 5/04

(52) U.S. Cl. CPC H01M 4/921; C22C 5/04; H01M 8/1018; H01M 4/925; H01M 2008/1095

(57) ABSTRACT

The present invention concerns electrode catalysts used in fuel cells, such as proton exchange membrane (PEM) fuel cells. The invention is related to the reduction of the noble metal content and the improvement of the catalytic5 efficiency by low level substitution of the noble metal to provide new and innovative catalyst compositions in fuel cell electrodes. The novel electrode catalysts of the invention comprise a noble metal selected from Pt and Pd alloyed with a lanthanide metal.

### FIELD OF THE INVENTION

The present invention concerns electrode catalysts used in fuel cells (e.g., in proton exchange membrane (PEM) fuel cells—also known as polymer electrolyte membrane fuel cells). The invention is related to the reduction of the noble metal content and the improvement of the catalytic efficiency and stability of the catalyst by low level substitution of the noble metal to provide new and innovative catalyst compositions in fuel cell electrodes.

### BACKGROUND OF THE INVENTION

Fuel cells combine hydrogen and oxygen without combustion to form water and to produce direct current electric power. The process can be described as reverse electrolysis. Fuel cells have potential for stationary and portable power applications; however, the commercial viability of fuel cells for power generation in stationary and portable applications depends upon solving a number of manufacturing, cost, and durability problems.

Electrochemical fuel cells convert fuel and an oxidant to electricity and a reaction product. A typical fuel cell consists of a membrane and two electrodes, called a cathode and an anode. The membrane is sandwiched between the cathode and anode. Fuel, such as hydrogen, is supplied to the anode, where an electrocatalyst catalyzes the following reaction: 2H₂→4H⁺+4e⁻.

At the anode, hydrogen separates into hydrogen ions (protons) and electrons. The protons migrate from the anode through the membrane to the cathode. The electrons migrate from the anode through an external circuit in the form of an electric current. An oxidant, in the form of oxygen or oxygen-containing air, is supplied to the cathode, where it reacts with the hydrogen ions that have crossed the membrane and with the electrons from the external circuit to form liquid water as the reaction product. The reaction is typically catalyzed by the platinum metal family. The reaction at the cathode occurs as follows: O₂+4H⁺+4e⁻→2H₂O. The successful conversion of chemical energy into electrical energy in a primitive fuel cell was first demonstrated over 160 years ago. However, in spite of the attractive system efficiencies and environmental benefits associated with fuel-cell technology, it has proven difficult to develop the early scientific experiments into commercially viable industrial products. Problems have often been associated with lack of appropriate materials that would enable the cost and efficiency of electricity production to compete with existing power technology.

Proton exchange membrane fuel cells have improved significantly in the past few years both with respect to efficiency and with respect to practical fuel cell design. Some prototypes of fuel-cell replacements for portable batteries and for automobile batteries have been demonstrated. However, problems associated with the cost, activity, and stability of the electrocatalyst are major concerns in the development of the polymer electrolyte fuel cell. For example, platinum (Pt)-based catalysts are the most successful catalysts for fuel cell and other catalytic applications. Unfortunately, the high cost and scarcity of platinum has limited the use of this material in large-scale applications. The development of low temperature polymer electrolyte membrane fuel cells is furthermore severely hampered by the fact that the oxygen reduction reaction (ORR) is slow, resulting in low catalytic activities, even using platinum as a catalyst.

In addition, a problem with the use of platinum at the anode has been the poisoning of the catalyst surface by carbon monoxide impurities. On the cathode side, usually higher catalyst loadings have been utilised because methanol and other carbon containing fuel passing through the membrane react with oxygen at the cathode under catalytic effect of platinum, thereby decreasing the efficiency of the fuel cell.

To improve the catalytic efficiency and reduce the cost, other noble metals and non-noble metals are used to form Pt alloys as catalysts. Noble metals including Pd, Rh, Ir, Ru, Os, Au, etc. have been investigated. Non-noble metals including Sn, W, Cr, Mn, Fe, Co, Ni, Cu (U.S. Pat. No. 6,562,499) have also been tried. Different Pt-alloys were disclosed as catalysts for fuel cell applications. Binary alloys as catalysts include Pt—Cr (U.S. Pat. No. 4,316,944), Pt—V (U.S. Pat. No. 4,202,934), Pt—Ta (U.S. Pat. No. 5,183,713), Pt—Cu (U.S. Pat. No. 4,716,087), Pt—Ru (U.S. Pat. No. 6,007,934), Pt—Ti, Pt—Cr, Pt—Mn, Pt—Fe, Pt—Co, Pt—Ni, Pt—Cu (GB 2 242 203). Ternary alloys as catalysts include Pt—Ru—Os (U.S. Pat. No. 5,856,036), Pt—Ni—Co, Pt—Cr—C, Pt—Cr—Ce (U.S. Pat. No. 5,079,107), Pt—Co—Cr (U.S. Pat. No. 4,711,829), Pt—Fe—Co (U.S. Pat. No. 4,794,054), Pt—Ru—Ni (U.S. Pat. No. 6,517,965), Pt—Ga—(Cr, Co, Ni) (U.S. Pat. No. 4,880,711), Pt—Co—Cr (U.S. Pat. No. 4,447,506). Quaternary alloys as catalysts include Pt—Ni—Co—Mn, (U.S. Pat. No. 5,225,391), Pt—Fe—Co—Cu (U.S. Pat. No. 5,024,905).

Furthermore, alloys of Pt or Pd with Sc, Y, or La suitable electrodes in a fuel cell are disclosed in WO 2011/006511. Pt₃Y, Pt₅Y, and Pt₅La are, in that order, the most active of the alloys tested therein. Pt₃Y, Pt₅Y, Pt₅La, and Pt₃La are further discussed as electrocatalysts by Greeley et al., Nature Chemistry, 2009, 1, 552; Stephens et al., ChemCatChem 2012, 4, 341; Stephens et al. Energy Environ. Sci. 2012, 5, 6744; and Yoo et al. (Energy Environ. Sci. 2012, 5, 7521). None of these disclose, however, alloying with lanthanide elements other than lanthanum itself. Yoo et al. correlates the d-band structure of Pt and charge transfer between Pt—La alloys (La having valence electrons in the d-shell) and their stability/activity. However, this is not predictive of the activity and stability of alloys with lanthanide elements other than La, having valence electrons in the f-shell. In addition, Yoo et al. comes to the conclusion that a Pt skin is energetically unfavourable and that metallic La exists on the surface. This is in contradiction to the experimental results reported by Stephens et al. (Energy Environ. Sci. 2012, 5, 6744).

Neto et al., Journal of Alloys and Compounds, 2009, 476, 288-291, disclose “Pt-rare earth catalysts”. The method employed is, however, incapable of reducing the rare earth elements and the catalysts are therefore not alloys.

However, for the PEM fuel cell to become a viable technology there is still a need to increase the catalytic activity, increase stability of the catalyst, and/or decrease the cost of the electrodes. Since the cost of the expensive ion conducting membrane separating the electrodes scales with the geometric area/active-site density of the electrode, the reduction of cost by using cheaper but less active electrodes with lower active-site density would be offset by the increasing cost of the membrane. Moreover, a decreased active site density cannot be offset by utilizing an electrode with a greater thickness: this would also impede the transport of reactive gases. As an example, reference should be made to the so-called Fe/C/N electrodes as disclosed inter alia by Lefevre et al., Science, 324, 71(2009). They have turnover frequencies, i.e. the number of electrons produced per active site per second, comparable to platinum electrodes, but still have lower active-site density.

Japanese patent application JP 10 214630 A discloses the use of binary alloys containing noble metals and rare earth metals in polymer electrolyte fuel cells. The only specific alloys disclosed in JP 10 214630 all have a low atomic ratio of Pt:lanthanide. Such low atomic ratios have been found by the present inventors to provide an unstable alloy when used in a fuel cell under normal running conditions and to provide alloys with lower activity.

Korean patent application KR 2003 0030686 discloses a metal cathode for an electron tube comprising a metal alloy having, as a main component, Pt₅La, Pt₃Sc, Pt₂Ti, Pt₄Y, Pt₃Y, Pt₅Hf, PtEr, or Pt₅Ce, and 0.1 to 20% by weight of one or more metals selected from the group consisting of molybdenum, tantalum and tungsten. The cathode further comprises 0.5 to 25% by weight of one or more elements selected from the group consisting of barium, strontium, and calcium. There is no indication, however, that the cathode may be useful for other uses than for an electron tube.

Japanese patent application JP 2005 340418 A discloses a platinum alloy film for use as a ferroelectric capacitor. The alloy may contain a maximum of 8% Nd or Gd.

Accordingly, it is an object of the invention to provide an electrode alloy material with an increased catalytic activity towards oxygen reduction compared to pure platinum and an increased stability under normal operating conditions. It is furthermore an object of the invention to provide an electrode alloy with a lower cost compared to pure platinum while retaining a comparable active-site density. Another object of the invention is to provide an electrode alloy material whose activity enhancement over Pt is stable over extended periods of time.

### SUMMARY OF THE INVENTION

The inventors of the present invention have found that the above described objects may be achieved by one aspect of the invention by providing an electrode comprising an alloy containing one or more noble metals selected from Pd, Pt and mixtures thereof, and at least one lanthanide metal, wherein said alloy is supported on a conductive support material, with the proviso that if said alloy is Pt₅Ce, then said electrode does not also contain 0.1 to 20% by weight of one or more metals selected from the group consisting of molybdenum, tantalum and tungsten, and 0.5 to 25% by weight of one or more elements selected from the group consisting of barium, strontium, and calcium, and, wherein the atomic ratio between said one or more noble metals and said at least one other element is in the range 2.5:1 to 20:1.

In another aspect, the invention concerns a fuel cell comprising the electrode of the present invention and an electrolyte.

In a further aspect, the invention relates to the use of an alloy according to the invention as an electrocatalyst.

In a further aspect, the invention relates to the use of an alloy according to the invention, wherein the alloy comprises a surface layer of pure noble metal—a layer described as noble metal skin (e.g. Pt skin) throughout this application.

It has been found that the electrodes of the present invention are up to six times more active than pure platinum. Furthermore, since the electrodes of the present invention are alloys with non-precious metals rather than pure platinum, the cost of the electrodes has been reduced while at the same time maintaining the active-site density.

### BRIEF DESCRIPTION OF THE DRAWINGS

FIG. 1 is a schematic diagram showing a schematic of a fuel cell, in which the catalyst of the invention is used at the electrode of the fuel cell.

FIG. 2 contains cyclic voltammograms for Pt, Pt₅Gd and Pt₅Sm.

FIG. 3 shows the activities of Pt₅Ce, Pt₅Sm, Pt₅Gd, Pt₅Dy and Pt₅Tm compared to that of Pt and Pt₃Y as measured by carrying out cyclic voltammograms in O₂ saturated electrolyte (only the anodic sweep has been shown).

FIG. 4 is a graphical representation which illustrates the specific activity as a function of the electrode potential, U, for Pt₅Ce, Pt₅Sm, Pt₅Gd, Pt₅Dy and Pt₅Tm compared to that of Pt and Pt₃Y, expressed as a kinetic current density, jₖ.

FIG. 5 shows the overall ranking of activity of Pt₅Gd, Pt₅Sm, Pt₅Dy, Pt₅Ce, Pt₅La, Pt₅Tm and Pt.

FIG. 6 shows the angle-resolved XPS profiles of Pt₅Gd before (a) and after (b) the ORR, the latter illustrating the Pt-skin formation after electrochemistry.

FIG. 7 shows the specific activity of Pt₅Gd, expressed as a kinetic current density, jₖ, after (a) 10,000 cycles between 0.6 and 1.0 V, and (b) after 100 and 200 cycles, respectively, between 0.05 and 1.6V.

FIG. 8 shows the activities of Pt₅Gd as measured by carrying out cyclic voltammograms in O₂ saturated solution on the same material used for generating FIG. 7.

FIG. 9 shows the activities measured at 0.9 V of Pt₅Gd, Pt₅Ce, Pt₅La and Pt before and after a stability test consisting of 10 000 cycles between 0.6 and 1.0 V vs. RHE.

FIG. 10 contains X-ray diffraction traces of Pt, Pt₅Ce, Pt₅Sm, Pt₅Gd, Pt₅Dy and Pt₅Tm.

### DETAILED DESCRIPTION OF THE INVENTION

### Definitions and Nomenclature

### Alloy

An alloy is a partial or complete solid solution of one or more elements in a metallic matrix. Complete solid solution alloys give single solid phase microstructure, while partial solutions give two or more phases that may be homogeneous in distribution depending on thermal (heat treatment) history.

Alloys usually have different properties from those of the component elements.

### Intermetallic Compound

In the present context, the term “intermetallic compound” refers to those alloys which exist as a single ordered phase. Alloys don't necessarily need to be ordered or a single phase.

### Lanthanide Metal

In the context of the present invention, the term “lanthanide metal” is intended to include elements 58 thru 71, i.e. the elements from Ce to Lu. Thus the term “lanthanide metal” in the context of the present invention does not include La itself. In one embodiment, “lanthanide metal” includes Ce, Sm, Gd, Yb, and any mixtures thereof, e.g. Sm, Gd, Yb, and any mixtures thereof, such as Sm, Gd, and any mixtures thereof, particularly Gd.

### Electrocatalyst

In the context of the present invention, an “electrocatalyst” is a catalyst that participates in an electrochemical reaction. Catalyst materials modify and increase the rate of chemical reactions without being consumed in the process. Electrocatalysts are a specific form of catalysts that function at electrode surfaces or may be the electrode surface itself. When an electrocatalyst functions heterogeneously, it is typically a solid, such as a planar platinum surface or platinum nanoparticles. When an electrocatalyst functions homogeneously, such as a co-ordination complex or enzyme, it will be in the liquid phase. The electrocatalysts assist in transferring electrons between the electrode and reactants and/or facilitates an intermediate chemical transformation described by overall half-reactions.

### Electrochemical Cell

In the context of the present invention, an “electrochemical cell” is a device used for generating an electromotive force (voltage) and current from chemical reactions, or the reverse, inducing a chemical reaction by a flow of current. The current is caused by the reactions releasing and accepting electrons at the different ends of a conductor. An “electrochemical cell” contains at least two electrodes and at least one electrolyte separating the electrodes. The electrolyte may be a liquid solution or an ion conducting membrane, which allows the passage of ions to reestablish charge neutrality over the whole cell without allowing any significant passage of electrons. Suitable electrolytes for electrochemical cells are known to the person skilled in the art. One example of a suitable electrolyte for certain types of electrochemical cells, such as a fuel cell, is Nafion®. An example of a suitable liquid electrolyte is phosphoric acid.

### Fuel Cell

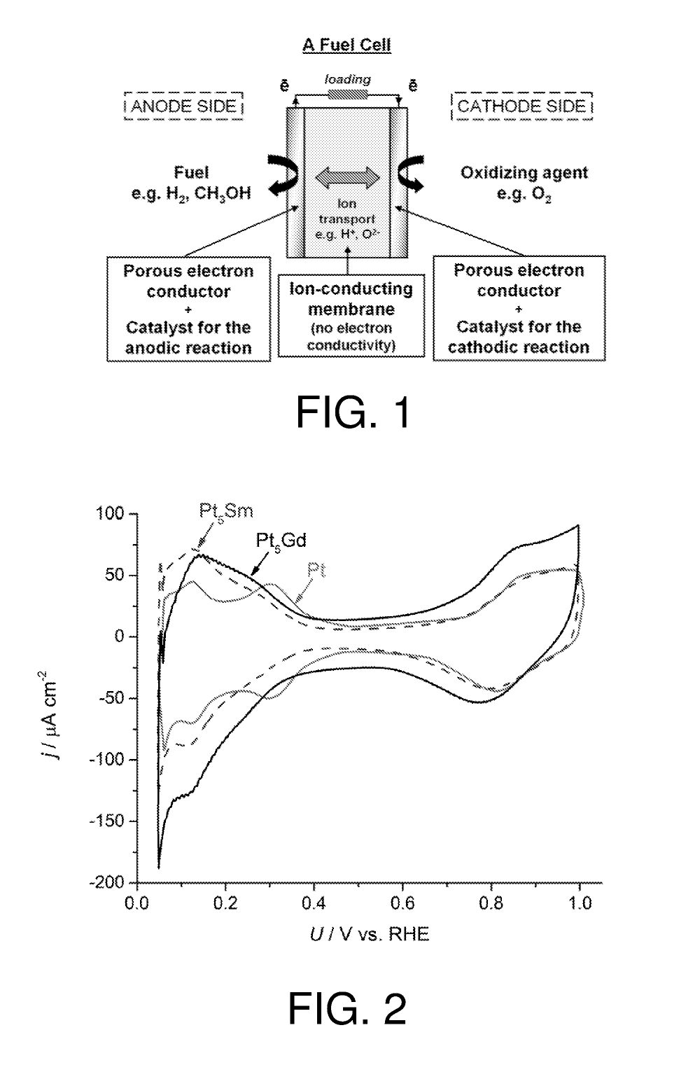

In the context of the present invention, a “fuel cell” is an electrochemical cell where the energy of a reaction between a fuel and an oxidant is converted directly into electrical energy. A typical fuel cell is illustrated in FIG. 1. Examples of fuels suitable for fuel cells are hydrogen gas, H₂, and methanol. A typical oxidant is oxygen gas, O₂.

### Conductive Support

The term “conductive support material” or “conductive support” means a solid material with a resistivity at 20° C. of at the most 700 ohm meter, preferably at the most 1 ohm meter, most preferably at the most 0.001 ohm meter. The “conductive support material” as used in the present invention is suitable for use in a fuel cell. In some of the embodiments of the invention it may be desirable that the conductive support material is permeable to gaseous molecules.

The term “conductive support material” or “conductive support” also includes non-conductive support materials with an electrode backing layer or any other means of conduction, wherein the means of conduction is attached to the non-conductive support material in a manner to bring it into contact with the electrocatalyst material to be deposited on the support material. One example of this type of “conductive support material” may be found in U.S. Pat. No. 5,338,430 and U.S. Pat. No. 6,040,077, both of which are incorporated herein in their entirety. U.S. Pat. No. 6,040,077 discloses PEM fuel cells with Pt or Pt/Ru deposited on an organic, non-conducting support material, so-called whiskers. The whiskers are acicular nanostructures grown on a substrate. The catalyst electrodes in U.S. Pat. No. 6,040,077 with the non-conductive support material are covered with ELAT™ electrode backing material for completing the electric circuit.

### Anode and Cathode

An electrode in an electrochemical cell, such as a fuel cell, may be referred to as either an anode or a cathode. The anode is defined as the electrode, at which electrons leave the cell and oxidation occurs, and the cathode, as the electrode at which electrons enter the cell and reduction occurs. An electrode may become either an anode or a cathode depending on the voltage applied to the cell as well as the design of the cell.

### Ion Conducting Membrane

In order to create an electrochemical circuit in a fuel cell, the electrodes may be separated by an ion conducting membrane. The membrane separating the electrodes must allow the diffusion of ions from one electrode to the other, but must keep the fuel and oxidant gases apart. It must also prevent the flow of electrons. Diffusion or leakage of the fuel or oxidant gases across the membrane can lead to undesirable consequences, such as short-circuiting or catalyst poisoning. If electrons can travel through the membrane, the device is fully or partially shorted out, and the useful power produced is eliminated or reduced. Suitable ionic conducting membranes include, but are not limited to Nafion, silicon oxide Nafion composites, polyperfluorosulfonic acids, polyarylene thioether sulfones, polybenzimidazoles, alkali-metal hydrogen sulfates, polyphosphazenes, sulfonated (PPO), silicapolymer composites, organo-amino anion exchange membranes and the like.

Ion conducting membranes suitable for use in fuel cells are generally very costly and the viability of using fuel cells commercially depends, at least in part, on minimising the amount of ion conducting membranes used in the fuel cell.

### Nanoparticles

In applications, such as fuel cells, the electrocatalyst of the invention may advantageously be applied in the form of nanoparticles. In general, nanoparticles have the advantage of high surface areas per weight, which make them interesting in applications where high surface areas are advantageous, such as in catalysts. In the case of very costly catalysts, said surface area to weight ratio obviously becomes even more important.

The electrocatalyst material according to the present invention may be converted into nanoparticles suitable for use in fuel cells by applying methods well known to the person skilled in the art. Examples of such methods may inter alia be found in U.S. Pat. No. 5,922,487, U.S. Pat. No. 6,066,410, U.S. Pat. No. 7,351,444, US 2004/0115507, and US 2009/0075142.

### Noble Metal Skin

In the context of the present invention, the term “noble metal skin” refers to the case when the alloys as used in the present invention have a relative intensity of noble metal of approximately 100% at or near the surface of the alloy, coinciding with a relative intensity of the one or more lanthanide metals of approximately 0%, as measured by Angle Resolved X-ray Photoelectron Spectroscopy (ARXPS). Beyond the noble metal skin, i.e. deeper into the surface of the alloy, the relative intensities of noble metal and the one or more lanthanide metals of the alloy will approach constant values corresponding to the bulk composition of the alloy, e.g. corresponding to Pt₅Gd.

### EMBODIMENTS OF THE INVENTION

The present invention concerns an electrode comprising a noble metal alloy. Noble metals are known in the art to be among the best catalysts in fuel cells. By instead using a noble metal alloy it is possible not only to decrease the cost of the electrode by substituting the very expensive noble metal with less expensive metals, but also to increase the activity of the electrode. Many efforts have been put into developing these alloys of noble metals, such as platinum and palladium, with other transition metals like Cr, Co, V, Ni. However, the operating potential at a given current density of fuel cells employing these prior art alloy catalysts decreases with time towards that of fuel cells employing pure Pt electrocatalysts. A review of some of these prior art alloy catalysts may be found in Gasteiger et al, Appl. Catal. B-Environ 56, 9-35 (2005). By using the present invention, noble metal alloys comprising lanthanide metals are surprisingly solving both problems by ensuring the stability together with an increased activity of the electrode. The activity of the Pt₅Gd, Pt₅Sm or Pt₅Dy electrode may be as much as an order of magnitude higher than the pure Pt electrode, as demonstrated in FIG. 4.

It has furthermore been found that the alloys comprised in the electrodes of the invention form noble metal overlayers—so-called noble metal “skins”—at the surface of the alloy. The depth of the skin is from one to several layers of noble metal, such as 1, 2, 3, or 4 layers of noble metal, such as platinum. This is important in order to ensure stability of the electrodes under the high potentials and acidic conditions of PEM fuel cells.

The invention relates to an electrocatalyst alloy supported on a conductive support. The support serves several different purposes. First, it serves the purpose of simply supporting the catalyst material, which may be deposited on the support in a very large area in a very thin layer. This holds the advantage of minimizing the needed mass of catalyst material to cover a large surface area of the catalyst. To optimize this effect, supports made with various surface porosities and roughness can increase the surface area of the support and hence the catalyst. Also more exotic supports, such as carbon nanotubes, have been investigated for these purposes. Furthermore, the support serves as a conducting material by providing a pathway for electronic (and in some cases ionic) conduction to and from the active sites of the catalyst. Finally, the support may also be gas permeable in order to facilitate the transport of gases to the catalyst.

In an embodiment of the invention, the noble metal used in the alloy is platinum. Platinum has long been known to be one of the best catalysts for the cathodic reaction. One of the drawbacks is the very high cost. Several attempts to improve cost efficiency have been made, such as depositing thin layers of Pt or alloying with cheaper materials or both. By alloying according to the present invention platinum can be used in very small amounts due to the increased activity of the alloys and the cheaper costs of lanthanide metals.

One aspect of the present invention concerns an electrode comprising an alloy containing one or more noble metals selected from Pd, Pt, and mixtures thereof, and at least one lanthanide metal, wherein said alloy is supported on a conductive support material, and wherein the atomic ratio between said one or more noble metals and said at least one lanthanide metal is in the range 2.5:1 to 20:1.

The noble metal of the alloy may be either platinum, gold or palladium, as well as any mixture thereof. In one embodiment, the noble metal is substantially pure platinum. In another embodiment, the noble metal is substantially pure palladium. In the embodiment of the invention, wherein the alloy contains a mixture of platinum and palladium, the mixture may comprise platinum and palladium in any ratio, such as in the atomic ratio 1:1.

Gold may be included in the electrode of the invention by depositing it on the surface of the alloy. As an example, gold may be deposited on the surface of a platinum/gadolinium alloy.

In the context of the present invention, when referring to substantially pure metals or alloys, such as “substantially pure platinum”, it is meant to encompass pure metals or alloys with a degree of impurities, which do not significantly alter the properties of the electrodes of the invention, e.g. the activity of the electrodes, within the normal measurement uncertainty limits applied by the skilled person.

The alloy of the electrode according to the present invention comprises one or more further elements, one or more lanthanide metals, which are elements 58 thru 71, i.e. the elements from Ce to Lu, as well as any mixtures thereof. The skilled person will understand that the elements from Ce to Lu include Ce, Pr, Nd, Pm, Sm, Eu, Gd, Tb, Dy, Ho, Er, Tm, Yb, and Lu. In one embodiment, said one or more lanthanide metals are the elements 62 thru 71, i.e. the elements from Sm to Lu. In a further embodiment, said one or more lanthanide metals are selected from the group consisting of cerium, gadolinium, samarium, dysprosium, thulium, ytterbium, and mixtures thereof. In yet a further embodiment, said one or more lanthanide metals are selected from the group consisting of cerium, gadolinium, samarium, dysprosium, ytterbium, and mixtures thereof. In another embodiment, said one or more lanthanide metals are selected from the group consisting of gadolinium, samarium, ytterbium, and mixtures thereof. In still another embodiment, said one or more lanthanide metals are selected from the group consisting of gadolinium, samarium, and mixtures thereof. In a further embodiment, said lanthanide metal is substantially pure gadolinium. In another embodiment, said lanthanide metal is substantially pure samarium.

In one embodiment of the invention, the alloy of the electrode consists of a substantially pure mixture of platinum and samarium. In another embodiment of the invention, the alloy of the electrode consists of a substantially pure mixture of platinum and gadolinium. In yet another embodiment, the alloy of the electrode consists of a substantially pure mixture of platinum and ytterbium.

As mentioned above, the invention also concerns electrodes comprising alloys of mixtures of noble metals and/or further lanthanide metals. Said alloys may therefore also be ternary alloys or quaternary alloys. Mixtures of five or more metals are also contemplated as being encompassed by the present invention.

In the electrode of the invention, the ratio between the one or more noble metals and the one or more further elements, the one or more non-noble metals, may vary. In a further embodiment, the present invention relates to an electrode, wherein the atomic ratio between the one or more noble metals and the one or more lanthanide metals is in the range 10:1 to 2.8:1, e.g. in the range 6:1 to 2.9:1, such as in the range 5:1 to 3:1. In yet a further embodiment, the atomic ratio between the one or more noble metals and the one or more lanthanide metals is in the range 3.5:1 to 2.5 to 1 or in the range 5.5:1 to 4.5:1.

Electrodes with an atomic ratio outside these ranges may be included in a PEM fuel cell. However, the excess of the noble or non-noble metals would be dissolved in the acidic electrolyte, leaving a catalyst with a composition inside the atomic ratio ranges indicated above.

Hence, the present invention encompasses an electrode comprising an alloy containing platinum and samarium with an atomic ratio in the range 20:1 to 2.5:1, such as in the range 10:1 to 2.8:1, e.g. in the range 6:1 to 2.9:1, such as in the range 5:1 to 3:1. In another embodiment, the present invention encompasses an electrode comprising an alloy containing platinum and samarium with an atomic ratio in the range 3.5:1 to 2.5 to 1 or in the range 5.5:1 to 4.5:1. Furthermore, the present invention encompasses an electrode comprising an alloy containing platinum and gadolinium with an atomic ratio in the range 20:1 to 2.5:1, such as in the range 10:1 to 2.8:1, e.g. in the range 6:1 to 2.9:1, such as in the range 5:1 to 3:1. In another embodiment, the present invention encompasses an electrode comprising an alloy containing platinum and gadolinium with an atomic ratio in the range 3.5:1 to 2.5 to 1 or in the range 5.5:1 to 4.5:1. In addition, the present invention encompasses an electrode comprising an alloy containing platinum and ytterbium with an atomic ratio in the range 20:1 to 2.5:1, such as in the range 10:1 to 2.8:1, e.g. in the range 6:1 to 2.9:1, such as in the range 5:1 to 3:1. In another embodiment, the present invention encompasses an electrode comprising an alloy containing platinum and ytterbium with an atomic ratio in the range 3.5:1 to 2.5 to 1 or in the range 5.5:1 to 4.5:1. Furthermore, the present invention encompasses an electrode comprising an alloy containing platinum and dysprosium with an atomic ratio in the range 20:1 to 2.5:1, such as in the range 10:1 to 2.8:1, e.g. in the range 6:1 to 2.9:1, such as in the range 5:1 to 3:1. In another embodiment, the present invention encompasses an electrode comprising an alloy containing platinum and dysprosium with an atomic ratio in the range 3.5:1 to 2.5 to 1 or in the range 5.5:1 to 4.5:1. In addition, the present invention encompasses an electrode comprising an alloy containing platinum and thulium with an atomic ratio in the range 20:1 to 2.5:1, such as in the range 10:1 to 2.8:1, e.g. in the range 6:1 to 2.9:1, such as in the range 5:1 to 3:1. In another embodiment, the present invention encompasses an electrode comprising an alloy containing platinum and thulium with an atomic ratio in the range 3.5:1 to 2.5 to 1 or in the range 5.5:1 to 4.5:1.

In yet a further embodiment, the present invention relates to an electrode, wherein the alloy is Pt₅Gd. In the context of the present invention, the term “Pt₅Gd” is a mixture of Pt and Gd with the atomic ratio 5:1. The skilled person may, while measuring the composition of an electrode according to this embodiment of the invention, arrive at a measured ratio deviating slightly from the exact ratio 5:1. It is however envisioned that electrodes having a measured composition substantially equal to 5:1 are also encompassed by the scope of this embodiment, as long as said deviation is within the normal uncertainty limits accepted by the person skilled in the art.

In yet a further embodiment, the present invention relates to an electrode, wherein the alloy is Pt₅Sm. In the context of the present invention, the term “Pt₅Sm” is a mixture of Pt and Sm with the atomic ratio 5:1. The skilled person may, while measuring the composition of an electrode according to this embodiment of the invention, arrive at a measured ratio deviating slightly from the exact ratio 5:1. It is however envisioned that electrodes having a measured composition substantially equal to 5:1 are also encompassed by the scope of this embodiment, as long as said deviation is within the normal uncertainty limits accepted by the person skilled in the art.

In yet a further embodiment, the present invention relates to an electrode, wherein the alloy is Pt₃Yb. In the context of the present invention, the term “Pt₃Yb” is a mixture of Pt and Yb with the atomic ratio 3:1. The skilled person may, while measuring the composition of an electrode according to this embodiment of the invention, arrive at a measured ratio deviating slightly from the exact ratio 3:1. It is however envisioned that electrodes having a measured composition substantially equal to 3:1 are also encompassed by the scope of this embodiment, as long as said deviation is within the normal uncertainty limits accepted by the person skilled in the art.

In yet a further embodiment, the present invention relates to an electrode, wherein the alloy is Pt₃Sm. In the context of the present invention, the term “Pt₃Sm” is a mixture of Pt and Sm with the atomic ratio 3:1. The skilled person may, while measuring the composition of an electrode according to this embodiment of the invention, arrive at a measured ratio deviating slightly from the exact ratio 3:1. It is however envisioned that electrodes having a measured composition substantially equal to 3:1 are also encompassed by the scope of this embodiment, as long as said deviation is within the normal uncertainty limits accepted by the person skilled in the art.

In yet a further embodiment, the present invention relates to an electrode, wherein the alloy is Pt₃Gd. In the context of the present invention, the term “Pt₃Gd” is a mixture of Pt and Gd with the atomic ratio 3:1. The skilled person may, while measuring the composition of an electrode according to this embodiment of the invention, arrive at a measured ratio deviating slightly from the exact ratio 3:1. It is however envisioned that electrodes having a measured composition substantially equal to 3:1 are also encompassed by the scope of this embodiment, as long as said deviation is within the normal uncertainty limits accepted by the person skilled in the art.

In yet a further embodiment, the present invention relates to an electrode, wherein the alloy is Pt₅Yb In the context of the present invention, the term “Pt₅Yb” is a mixture of Pt and Yb with the atomic ratio 5:1. The skilled person may, while measuring the composition of an electrode according to this embodiment of the invention, arrive at a measured ratio deviating slightly from the exact ratio 5:1. It is however envisioned that electrodes having a measured composition substantially equal to 5:1 are also encompassed by the scope of this embodiment, as long as said deviation is within the normal uncertainty limits accepted by the person skilled in the art.

In yet a further embodiment, the present invention relates to an electrode, wherein the alloy is Pt₅Dy. In the context of the present invention, the term “Pt₅Dy” is a mixture of Pt and Dy with the atomic ratio 5:1. The skilled person may, while measuring the composition of an electrode according to this embodiment of the invention, arrive at a measured ratio deviating slightly from the exact ratio 5:1. It is however envisioned that electrodes having a measured composition substantially equal to 5:1 are also encompassed by the scope of this embodiment, as long as said deviation is within the normal uncertainty limits accepted by the person skilled in the art.

In yet a further embodiment, the present invention relates to an electrode, wherein the alloy is Pt₃Dy. In the context of the present invention, the term “Pt₃Dy” is a mixture of Pt and Dy with the atomic ratio 3:1. The skilled person may, while measuring the composition of an electrode according to this embodiment of the invention, arrive at a measured ratio deviating slightly from the exact ratio 3:1. It is however envisioned that electrodes having a measured composition substantially equal to 3:1 are also encompassed by the scope of this embodiment, as long as said deviation is within the normal uncertainty limits accepted by the person skilled in the art.

In yet a further embodiment, the present invention relates to an electrode, wherein the alloy is Pt₅Tm. In the context of the present invention, the term “Pt₅Tm” is a mixture of Pt and Tm with the atomic ratio 5:1. The skilled person may, while measuring the composition of an electrode according to this embodiment of the invention, arrive at a measured ratio deviating slightly from the exact ratio 5:1. It is however envisioned that electrodes having a measured composition substantially equal to 5:1 are also encompassed by the scope of this embodiment, as long as said deviation is within the normal uncertainty limits accepted by the person skilled in the art.

In yet a further embodiment, the present invention relates to an electrode, wherein the alloy is Pt₃Tm. In the context of the present invention, the term “Pt₃Tm” is a mixture of Pt and Tm with the atomic ratio 3:1. The skilled person may, while measuring the composition of an electrode according to this embodiment of the invention, arrive at a measured ratio deviating slightly from the exact ratio 3:1. It is however envisioned that electrodes having a measured composition substantially equal to 3:1 are also encompassed by the scope of this embodiment, as long as said deviation is within the normal uncertainty limits accepted by the person skilled in the art.

As mentioned above, alloys may exist in a single ordered phase, which is referred to as an “intermetallic compound” in the present context. In a presently preferred embodiment, the alloys of the electrodes according to the invention contain at least 70% by weight intermetallic compound, such as at least 75% by weight, 80% by weight, 85% by weight, 90% by weight, or 95% by weight. In another embodiment, the alloy contains substantially only intermetallic compound.

As an example, the embodiment wherein the alloy is Pt₅Gd may contain at least 70% intermetallic compound, i.e. at least 70% of the Pt₅Gd is in a single ordered phase.

As discussed above, KR 2003 0030686, even though it pertains to the remote field of electron tubes, discloses electrodes comprising Pt₅Ce. Hence, any embodiment of the electrode of the present invention encompassing Pt₅Ce does not also contain 0.1 to 20% by weight of one or more metals selected from the group consisting of molybdenum, tantalum and tungsten, and 0.5 to 25% by weight of one or more elements selected from the group consisting of barium, strontium, and calcium.

In a further aspect, the present invention relates to a fuel cell comprising the electrode according to the invention.

While the electrode of the invention is envisioned for use in any type of electrochemical cell, the inventors of the present invention have found that it is particularly useful in fuel cells in the conversion of chemical energy into electric energy. It has further been found that the electrodes of the present invention are especially useful in low-temperature fuel cells, i.e. fuel cells operating below 300° C., such as in the range 0° C. to 300° C.

The electrodes of the present invention may function either as the anode or the cathode of a fuel cell, depending on the voltage and design of the fuel cell. The electrodes of the invention are however preferably used as cathodes.

In yet a further aspect, the present invention relates to the use of the alloy as defined herein as an electrocatalyst.

In still a further aspect, the present invention relates to a method for the production of electrical energy comprising the step of supplying an oxidizable fuel, such as H₂ or methanol, and an oxidant, such as O₂, to a fuel cell, such as a low-temperature fuel cell, as defined herein.

The different embodiments of the present invention may be combined with any of the other embodiments.

Throughout this document the terms “comprising” or “comprises” do not exclude other possible elements or steps. Also, the mentioning of references such as “a” or “an” etc. should not be construed as excluding a plurality.

### Examples

### Electrodes

Each electrode was 5 mm in diameter (0.196 cm² geometric surface area). The alloys were produced as standard alloys according to techniques well known in the art of alloy production. Upon specification, several providers around the world will produce the alloys according to standard practice. One such provider is Mateck GmbH in Germany. The specification for the Pt₅Ce, Pt₅Sm, Pt₅Gd, Pt₅Dy and Pt₅Tm electrodes used in these examples was: purity 99.95%, dia. 5+/−0.05 mm×thickness 3+/−0.5 mm, one side polished.

### Electrochemical Measurements

Within a few seconds of removing the electrode from the UHV chamber, the clean electrode was protected using a droplet of ultrapure water (Millipore Milli-Q water, 18 MΩcm⁻¹), saturated with H₂. It was then placed face down onto a wet polypropylene film, and pressed into the arbor of a rotating disc electrode (RDE).

The electrochemical experiments were performed with Bio-Logic Instruments' VMP2 potentiostat, controlled by a computer. The RDE assemblies were provided by Pine Instruments Corporation. A standard three-compartment glass cell was used. Prior to each measurement, the cell was cleaned a “piranha” solution consisting of a 3:1 mixture of 96% H₂SO₄ and 30% H₂O₂, followed by multiple runs of heating and rinsing with ultrapure water (Millipore Milli-Q, 18.2 MΩcm) to remove sulphates. The electrolyte, 0.1 M HClO₄ (Merck Suprapur) was prepared from ultrapure water. The counter electrode was a Pt wire and the reference was a Hg/Hg₂SO₄ electrode; both were separated from the working electrode compartment using ceramic frits. Following each measurement, the potential of the reference electrode was checked against a reversible hydrogen electrode (RHE) in the same electrolyte. All potentials are quoted with respect to the RHE, and are corrected for Ohmic losses. The measurements were conducted at room temperature (23±2° C.). Following each measurement, 0 V vs. RHE was established by carrying out the hydrogen oxidation and hydrogen evolution reactions on Pt in the same electrolyte. The ohmic drop was measured by carrying out an impedance spectrum with a peak-to-peak amplitude of 10 mV, typically from 500 kHz down to 100 Hz. The target resistance was evaluated from the high-frequency intercept on the horizontal (real) axis of the Nyquist plot and further checked by fitting the impedance spectra by using EIS Spectrum Analyser software [9]. The uncompensated resistance came typically to approximately 30Ω, and was independent of the potential, rotation speed and the presence of O2.

The RDE was immersed into the cell under potential control at 0.05 V into a N₂ (N5, Air Products) saturated electrolyte.

The oxygen reduction reaction (ORR) activity measurements were conducted in an electrolyte saturated with O₂ (N55, Air Products). The electrode was cycled in nitrogen-saturated electrolytes until stable cyclic voltammograms (CVs) where obtained (100-200 cycles). A typical stable CV on sputtered-cleaned Pt₅Gd and Pt₅Sm is shown in FIG. 2, and compared to the base CV on polycrystalline Pt. The ORR activity measurements were conducted in an electrolyte saturated with O₂ (N55, Air Products).

### Angle Resolved X-Ray Photoelectron Spectroscopy

X-ray photoelectron spectroscopy (XPS) is a surface analysis technique, usually implemented ex-situ under ultra high vacuum conditions (Chorkendorff and Niemantsverdriet, Concepts of Modern Catalysis and Kinetics, 2003). When an incident X-ray beam hits the surface, photoelectrons are emitted. The binding energy of these photoelectrons is characteristic of the elemental composition and chemical state of the atoms in the surface and near surface region. Varying the angle of the photoelectron analyser with respect to the normal to the sample allows different depth scales to be probed. Thus, angle resolved XPS allows a non-destructive depth profile to be obtained.

### Example 1

### Activities of the Electrodes

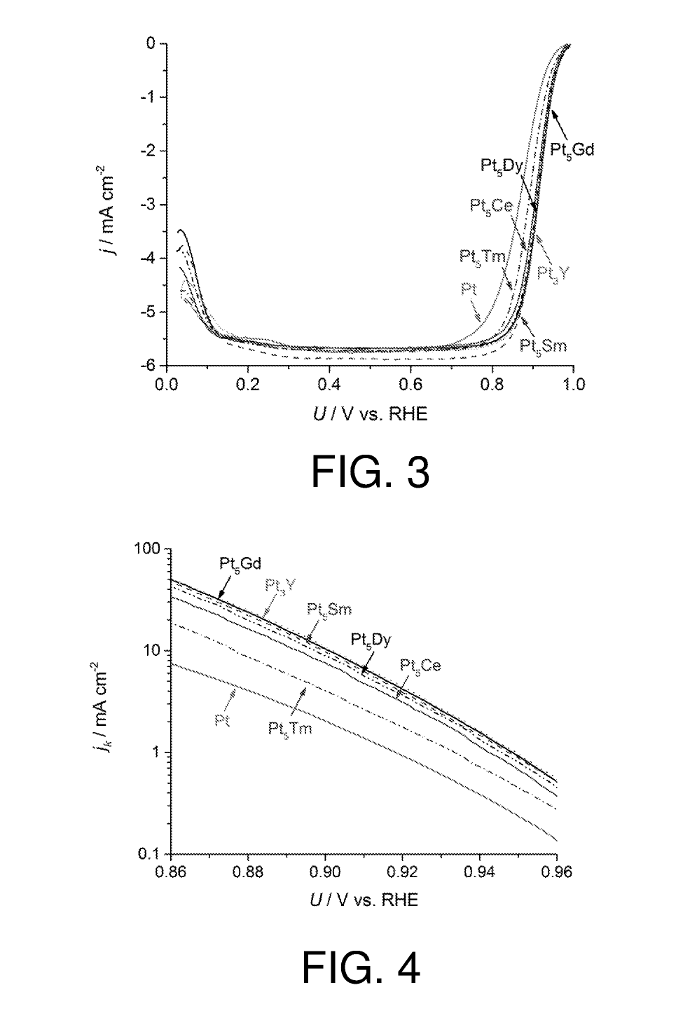

The activity of the catalysts for the ORR was measured by carrying out cyclic voltammograms in O₂ saturated solution, shown in FIG. 3. The onset for each electrode starts at ˜1 V, and there is an initial exponential increase in the current, characteristic of kinetic control (i.e. where the current is not limited by diffusion). At lower potentials (˜0.7 V<U<˜0.95 V), the current approaches the mixed regime, where mass transport (diffusion) plays an increasingly important role. This potential range is the most interesting for fuel cell applications, the operating potential of fuel cells is typically in this range. At still lower potentials, the current reaches its diffusion limited value, ˜5.8 mA cm⁻². In the mixed regime, the ORR activity of different catalysts can be compared by evaluating the half wave potential, U_{1/2} (i.e. the potential at which the current reaches half its diffusion limited value). Pt₅Ce, Pt₅Sm, Pt₅Gd, Pt₅Dy and Pt₅Tm alloys show a positive shift in U_{1/2}. In the case of Pt₅Gd, Pt₅Sm and Pt₅Dy the positive shift in U_{1/2} is of ˜50 mV. These data show that they exhibit significant activity improvements over Pt. The positive shift in half wave potential means that the diffusion limited value is reached at a higher potential, i.e. that the kinetics are faster than for pure platinum.

Modern PEM fuel cells have been designed for efficient delivery of reactive gases, thus mass transport effects are only of secondary importance; electrochemical kinetics are the primary cause of inefficiency (Gasteiger et al., Appl. Catal. B-Environ., 56, 9 (2005)). In FIG. 4, the measured current density is corrected for mass transport to obtain the true kinetic current density, jₖ, of the catalyst, as a function of potential, U.

The kinetic current density for oxygen reduction, jₖ, was calculated using the following equation:

1/jₖ=1/jₘₑₐₛ−1/j_{d}

where jₘₑₐₛ is the measured current density, and j_{d} is the diffusion limited current density.

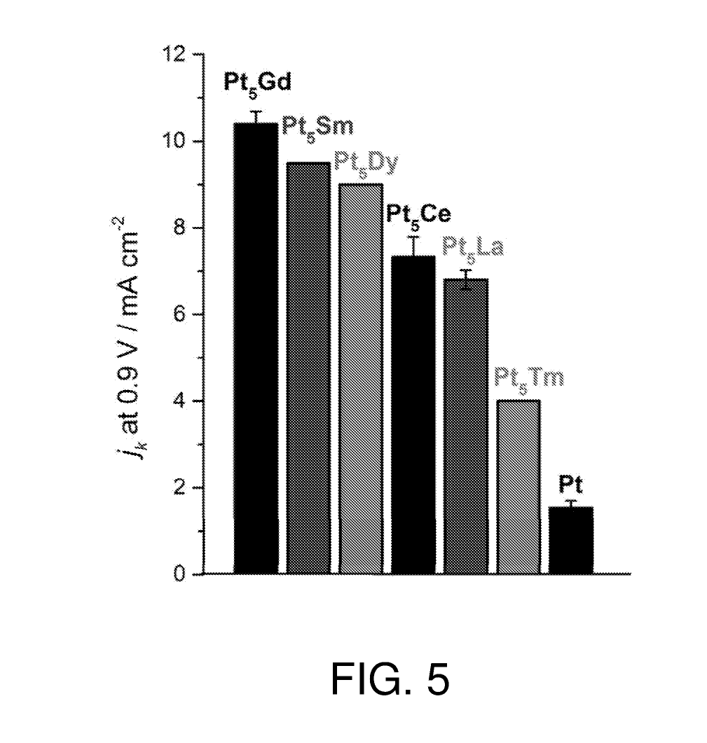

FIGS. 4 and 5 show that the same catalyst ranking is found as that determined by the half wave potential: activity increases in the following order: Pt<<Pt₅Tm<<Pt₅La<Pt₅Ce<<Pt₅Dy<Pt₅Sm<Pt₅Gd.

By extrapolation, the increase in activity is even higher at 0.7 V, the potential at which fuel cells are most commonly operated. Such a high increase in current at the same operating potential results in the increase of the output power with same factor. This is significant in the objective of achieving commercially viable fuel cells.

### Example 2

### ARXPS of Pt₅Gd

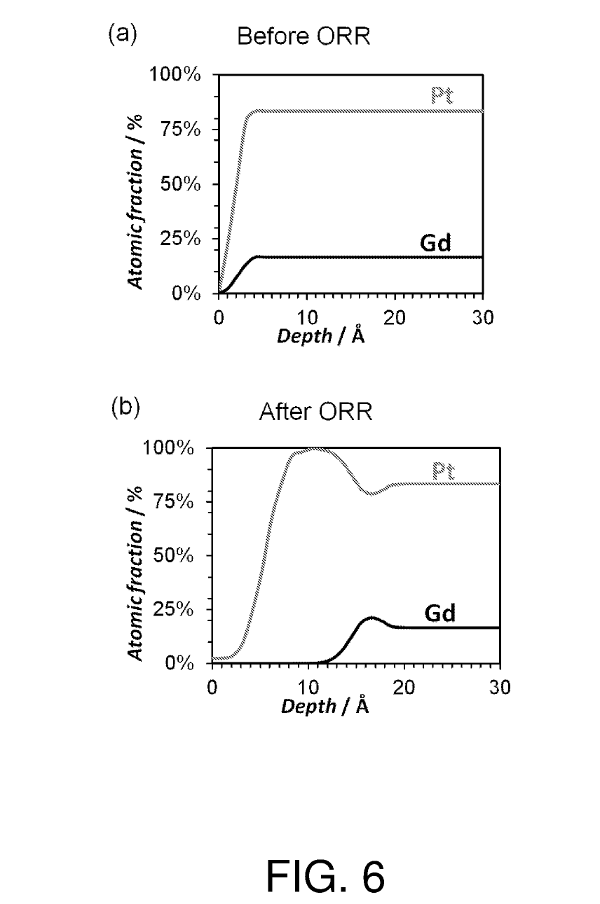

Evidence for a noble metal skin of the alloys as employed in the present invention is provided in FIG. 6, which contains two depth profiles of a Pt₅Gd sample, constructed from Angle Resolved X-ray Photoelectron Spectroscopy data. FIG. 6(a) shows depth profile of the alloy before being subjected to the ORR and FIG. 6(b) shows depth profile after being subjected to the ORR in an electrochemical cell. Evidently, a skin was formed by exposing the catalyst surface to acidic electrolyte, where the rare-earth metal, Gd, would dissolve spontaneously from the surface layer.

In-depth surface composition information of Pt₅Gd was extracted from AR-XPS spectra recorded using a Theta Probe instrument (Thermo Scientific). The chamber has a base pressure of 5×10⁻¹⁰ mbar. The instrument uses monochromatised AlKα (1486.7 eV) X-rays, and the electron energy analyzer has an acceptance angle of 60°. It facilitates XPS spectra recorded from within a diameter of 15 μm with a resolution corresponding to a Ag 3d_{5/2} full width half maximum (FWHM) smaller than 0.5 eV. The AR-XPS spectra were obtained in parallel, without tilting the sample. In consideration of the count statistics at the grazing angles, an X-ray beam size of 400 μm and an energy resolution corresponding to approximately 1 eV Ag 3d_{5/2} FWHM was used.

The surface was sputter cleaned with a 0.5 keV beam of Ar⁺ ions, with a current of 1 μA, over a 6×6 mm² area. This was typically continued for around 20 minutes, until the XPS measurement indicated that impurities were negligible. The XPS spectra were taken at several different locations over the metal surfaces.

For the depth profiles, the electrons emitted at angles between 20° and 80° to the surface normal were analysed in parallel and detected in 16 channels corresponding to 3.75° wide-angle intervals. After XPS identification of the elements present at the surface, their main features were measured in detail with AR-XPS. The depth concentration profiles were obtained using the simulation tool, ARProcess (Thermo Avantage software), which uses a maximum entropy method combined with a genetic algorithm. In all cases, the simulations were based on the relative intensities between Pt 4f, O 1s and C 1s, and Gd 4d at each angle, up to 70.6°. The most grazing angles were omitted from the analysis to reduce the influence of diffraction effects and elastic scattering.

### Example 3

### Stability of Pt₅Gd

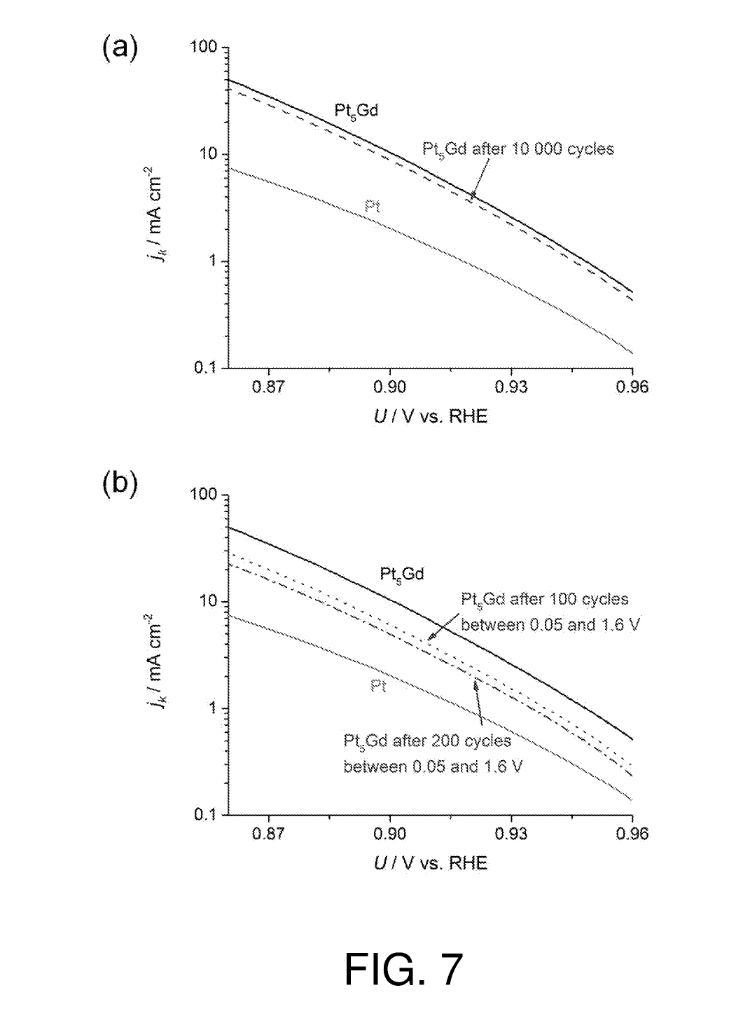

In order to study the stability of polycrystalline Pt₅Gd electrodes in acidic solutions, an accelerated stability test (test I) consisting of continuous cycles from 0.6 V to 1.0 V vs. RHE in an oxygen-saturated 0.1 M HClO₄ electrolyte at 100 mV s⁻¹ and 23° C. was performed. The CVs in an O₂-saturated 0.1 M HClO₄ solution before and after 10,000 cycles (after around 20 h of experiments) between 0.6 V and 1.0 V are shown in FIG. 7. FIG. 7(a) shows the Tafel plots for the ORR on Pt₅Gd before (full curve) and after (dashed curve) 10,000 cycles in the conditions described above. Interestingly, these results show that the percentage of activity loss after 10,000 cycles is 14° A), most of this loss occurring in the first 2000 cycles.

Following stability test I, the electrode was exposed to a more aggressive experiment, by cycling it between 0.05 V and 1.6 V (i.e., very strong corrosive conditions) at 50 mV s⁻¹ in O₂-saturated solutions (test II). After 10 cycles, no additional loss in activity in the ORR was observed. However, after 50 cycles between 0.05 V and 1.6 V the ORR polarization curve (after stability test I) could not be recovered. As shown in FIG. 7(b), the sample retains 59% of its initial activity after 100 cycles and 48% after 200 cycles (after ca. 30 hours of experiments).

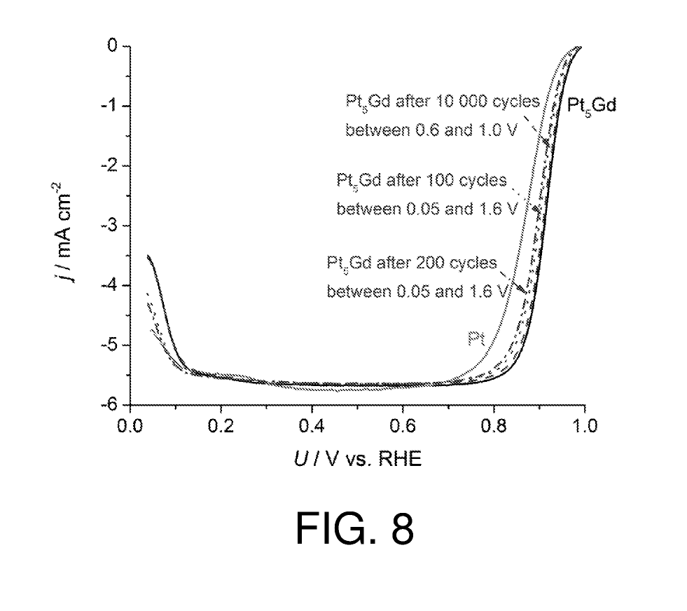

FIG. 8 shows the activities as measured by carrying out cyclic voltammograms in O₂-saturated solution on the same materials obtained in test I and II.

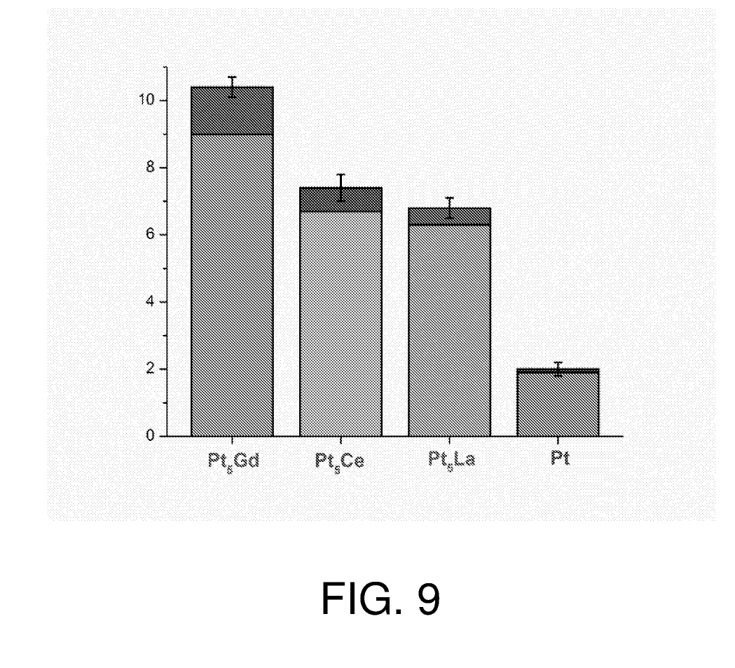

The rest of the alloys of Pt and lanthanides studied also exhibit a high stability. FIG. 9 shows the activities of Pt₅Gd, Pt₅Ce, Pt₅La and Pt before and after a stability test consisting of 10 000 cycles between 0.6 and 1.0 V vs. RHE at 100 mV s⁻¹.

### Example 4

### X-Ray Diffraction

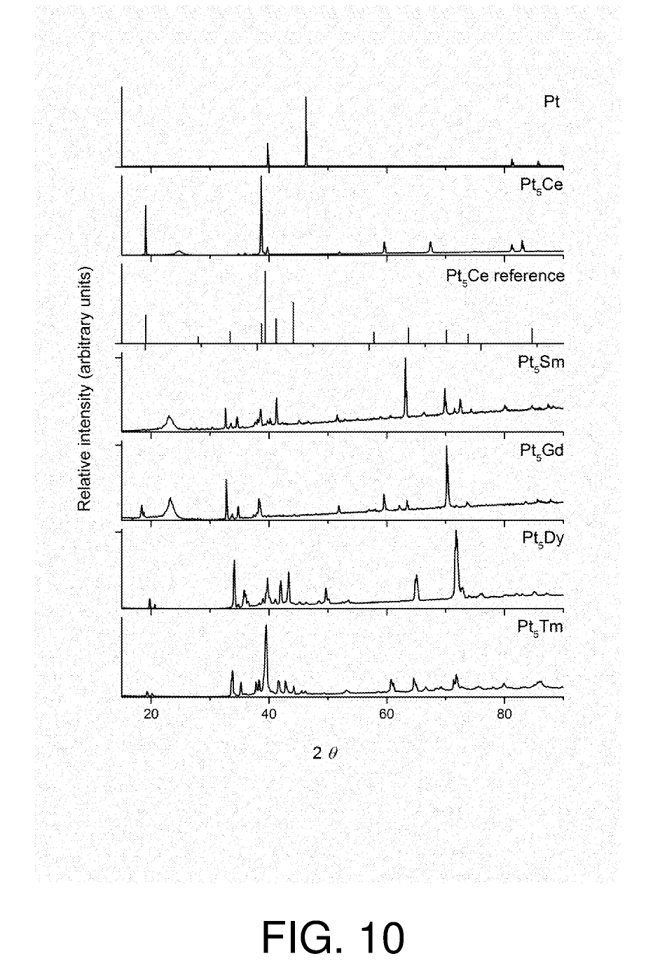

The bulk composition of each electrode was verified using X-ray diffraction (XRD), using a PANalytical X'Pert PRO instrument. The results of these measurements are shown in FIG. 10. The patterns for Pt and Pt₅Ce corresponded to the respective reference traces for these compounds, from the powder diffraction file database. There was no reference data available for Pt₅Sm, Pt₅Gd, Pt₅Dy and Pt₅Tm. For Pt₅Gd, XRD peaks match with two different phases, a hexagonal phase and an orthorhombic phase. The space group for Pt₅Sm, Pt₅Gd, Pt₅Dy and Pt₅Tm is unknown, although several works in the literature state that it should be similar to the Cu₅Ca structure.

Although the present invention has been described in connection with the specified embodiments, it should not be construed as being in any way limited to the presented examples. The scope of the present invention is set out by the accompanying claim set.

1. An electrode comprising:
an alloy comprising one or more noble metals selected from the group consisting of Pd, and Pt or mixtures thereof, and at least one lanthanide metal from Ce to Lu, wherein said alloy is supported on a conductive support material,
with the proviso that if said alloy is Pt₅Ce, then said electrode does not also contain 0.1 to 20% by weight of one or more metals selected from the group consisting of molybdenum, tantalum and tungsten, and 0.5 to 25% by weight of one or more elements selected from the group consisting of barium, strontium, and calcium, and,
wherein the atomic ratio between said one or more noble metals and said at least one lanthanide metal is in the range 2.5:1 to 10:1.

2-15. (canceled)

16. The electrode according to claim 1, wherein the noble metal is platinum.

17. The electrode according to claim 1, wherein said lanthanide metal is an element from Sm to Lu.

18. The electrode according to claim 1, wherein said lanthanide metal is Sm, Gd, or Yb, or mixtures thereof.

19. The electrode according to any one of the preceding claims, wherein said lanthanide metal is Sm, Gd, or mixtures thereof.

20. The electrode according to claim 1, wherein said lanthanide metal is Gd.

21. The electrode according to claim 1, wherein the atomic ratio between said one or more noble metals and said at least one lanthanide metal is in the range 2.8:1 to 10:1.

22. The electrode according to claim 1, wherein the atomic ratio between said one or more noble metals and said at least one lanthanide metal is in the range 3:1 to 8:1.

23. The electrode according to claim 1, wherein the atomic ratio between said one or more noble metals and said at least one lanthanide metal is between 3:1 and 5:1.

24. The electrode according to claim 1, wherein said alloy is Pt₅Gd.

25. The electrode according to claim 1, wherein said alloy is Pt₅Sm.

26. A fuel cell comprising the electrode according to claim 1 and an electrolyte.

27. The fuel cell according to claim 26, wherein the alloy of the electrode comprises a noble metal skin on the surface.

28. The fuel cell according to claim 26, wherein the electrolyte is an ion conducting membrane.

29. A method of using an alloy as an electrocatalyst comprising:
providing an alloy comprising one or more noble metals selected from the group consisting of Pd, and Pt or mixtures thereof, and at least one lanthanide metal from Ce to Lu, wherein said alloy is supported on a conductive support material,
with the proviso that if said alloy is Pt₅Ce, then said electrode does not also contain 0.1 to 20% by weight of one or more metals selected from the group consisting of molybdenum, tantalum and tungsten, and 0.5 to 25% by weight of one or more elements selected from the group consisting of barium, strontium, and calcium, and,
wherein the atomic ratio between said one or more noble metals and said at least one lanthanide metal is in the range 2.5:1 to 10:1; and
introducing said alloy into a fuel cell.
